(19) United States
(12) Patent Application Publication
(10) Pub. No.: US 2006/0081329 A1
(43) Pub. Date: Apr. 20, 2006

(54) Method of processing woven/knitted fabric and the like composed of thermal fusion bonding yarns

(76) Inventor: Yuzo Kikuchi, Tokyo (JP)

Correspondence Address: JORDAN AND HAMBURG LLP, 122 EAST 42ND STREET, SUITE 4000, NEW YORK, NY, 10168, US

(21) Appl. No.: 11/251,223

(22) Filed: Oct. 14, 2005

(30) Foreign Application Priority Data
Oct. 14, 2004 (JP) 2004-299550
Mar. 30, 2005 (JP) 2005-098527

(51) Int. Cl. B32B 37/00

(52) U.S. Cl. 156/251; 264/103; 264/345; 264/163

(57) ABSTRACT

In a method of processing woven/knitted fabric composed of thermal fusion bonding yarns, woven fabric, knitted fabric, or a braid, which is obtained by weaving or knitting thermal fusion bonding textile yarns such as thermal fusion bonding polyester and the like, is molded by being subjected to heat-processing. The molded product can be remolded by being subjected to heat-processing again. The woven fabric or the knitted fabric is a flat sheet or a three-dimensional woven/knitted fabric. It is also possible to partly overlapping the woven fabric or the knitted fabric on ordinary woven fabric or ordinary knitted fabric and to heat-molding them integrally with each other.

### BACKGROUND OF THE INVENTION

1. Field of the Invention

The present invention relates to a method of processing woven/knitted fabric and the like such as woven fabric, knitted fabric, a braid, and the like composed of thermal fusion bonding yarns such as thermal fusion bonding polyester yarns.

2. Description of the Related Art

Heretofore, there is a technology for thermally molding a sheet-like fabric which is used by being molded. The sheet-like fabric is manufactured by laminating non-woven fabric composed of ordinary polyester textile and non-woven fabric composed of thermal fusion bonding polyester textile through synthetic resin layers (for example, refer to Japanese Patent Application Laid-Open No. 9-21049). Further, heretofore, plastic products such as braids and the like that require strength are mainly processed by an injection molding machine using a metal mold.

However, since a sheet composed of laminated non-woven fabric composed of polyester yarns is thermally molded in the above conventional technology, products made by molding the sheet are defective in that they are less strong and, in particular, cannot be employed to molded products requiring strength. Further, since products processed by a conventional injection molding machine using a metal mold are defective in that they lack practical usability because they are damaged and broken due to the insufficient strength thereof as well as a metal mold for injection molding the plastic plates and the plastic sheets is expensive and further it is time-consuming to process them.

### SUMMARY OF THE INVENTION

Accordingly, an object of the present invention is to overcome the conventional problems and to provide a method of processing woven/knitted fabric composed of thermal fusion bonding yarns so that various types of commodities having strength can be expanded in a market. Further, an object of the present invention is to provide a method of processing woven/knitted fabric composed of thermal fusion bonding textile that can be manufactured at low cost in short time without using an expensive metal mold.

A method of processing woven/knitted fabric and the like composed of thermal fusion bonding yarns of the present invention is characterized by molding the woven fabric, the knitted fabric, or a braid made by weaving or knitting thermal fusion bonding textile yarns such as thermal fusion bonding polyester and the like by subjecting it to heat-processing. The woven fabric or the knitted fabric may be remolded by being subjected to heat processing again. The woven fabric or the knitted fabric may be a flat sheet. The woven fabric or the knitted fabric may be three-dimensional woven/knitted fabric. Further, the woven fabric or the knitted fabric may be partly overlapped on ordinary woven fabric or ordinary knitted fabric and heated and molded integrally with it.

A method of processing woven/knitted fabric, which is composed of thermal fusion bonding textile, of the present invention is characterized by melting and solidifying woven fabric or knitted fabric, which is composed of thermal fusion bonding textile such as thermal fusion bonding polyester and the like, by heating it, and cutting the woven fabric or the knitted fabric to a desired shape. A method of processing woven/knitted fabric, which is composed of thermal fusion bonding textile, is characterized by heating and melting the woven fabric or the knitted fabric composed of the thermal fusion bonding textile yarns such as thermal fusion bonding polyester and the like, and cutting the woven fabric or the knitted fabric to a desired shape simultaneously with the heating and melting step. A processing method is characterized by fusion cutting the woven fabric or the knitted fabric, which is composed of the thermal fusion bonding textile such as thermal fusion bonding polyester and the like to a desired shape, and melting and solidifying the woven fabric or the knitted fabric by heating it. It characteristically partly processes the woven/knitted fabric. It characteristically cuts the woven/knitted fabric while heat-molding it. It characteristically changes the thickness of the textile or the yarns of the woven/knitted fabric. Further, it characteristically colors the textile of the woven/knitted fabric.

According to the present invention, the following advantages can be achieved.

1) The molded product, which is made by the method of processing the woven/knitted fabric and the like, which is composed of the thermal fusion bonding yarns of the present invention, is advantageous in that the molded product makes it possible to expand various types of commodities having strength in a market.

2) A vinyl chloride sheet can be also heat-bonded using a thermal fusion bonding tape before it is thermally cured. In this case, strength can be maintained sufficiently. Further, processing can be executed flexibly by thermally fusion-bonding the tape after it is thermally cured.

3) Drill processing can be executed.

4) Since a conventional metal mold is not required in the processing of the present invention, it can be executed at low cost in short time.

5) Strength can be increased by changing the thickness of the textile or the yarns of narrow woven/knitted fabric as a material.

6) Belt-shaped woven fabric and a plastic part can be processed integrally with each other by thermally fusion-bonding narrow woven fabric partially in a lengthwise direction.

7) A colorful product can be made by coloring textile and yarns.

8) Various patterns can be formed by a structure of woven/knitted fabric.

9) Since a material is composed of narrow woven/knitted fabric, it can be sewed.

### BRIEF DESCRIPTION OF THE DRAWINGS

FIGS. 1A to 1C are views explaining a first embodiment of the present invention;

FIGS. 2A and 2B are views explaining a second embodiment of the present invention;

FIGS. 3A to 3B are views explaining an applied example of a molded product of the present invention;

FIGS. 4A to 4C are views explaining a third embodiment of the present invention;

FIGS. 5A and 5B are views explaining a fourth embodiment of the present invention;

FIGS. 6A to 6C are views explaining another applied example of the fourth embodiment of the present invention;

FIGS. 7A and 7B are views explaining a fifth embodiment of the present invention;

FIGS. 8A to 8C are views explaining a sixth embodiment of the present invention;

FIG. 9 is a perspective view explaining a state of use of a product processed by the method of FIG. 8;

FIG. 10 is a front elevational view of a product processed by a seventh embodiment of the present invention;

FIG. 11A shows a woven fabric material according to an eighth embodiment of the present invention, FIG. 11B is a front elevational view showing a processed product, and FIG. 11C is a perspective view explaining a state of use of the product; and

FIG. 12A shows a woven fabric material of a ninth embodiment of the present invention, FIG. 12B is a view explaining partial bonding processing of the woven fabric material, FIG. 12C is a view explaining cutting processing of the woven fabric material, and FIG. 11D is a view explaining a state of use of the woven fabric material.

### DESCRIPTION OF THE PREFERRED EMBODIMENTS

Respective embodiments of the present invention will be explained below with reference to the drawings.

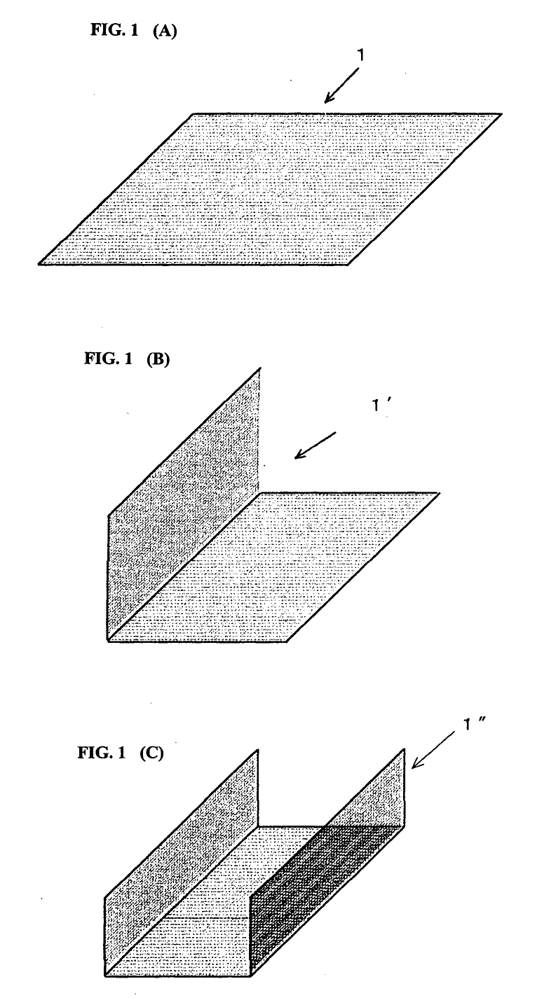

FIG. 1A is a view explaining a first embodiment of the present invention, wherein reference numeral 1 denotes a woven fabric whose warps and/or wefts are composed of thermal fusion bonding textile yarns such as thermal fusion bonding polyester and the like. The woven fabric 1 is molded to an arbitrary shape as shown in FIGS. 1B and 1C while being applied with heat and then solidified, thereby it is made to molded products 1′ and 1″. Yarns used in the woven fabric 1 need not be entirely composed of thermal fusion bonding textile yarns and may be appropriately mixed with ordinary polyester textile or yarns according to a purpose of a molded product.

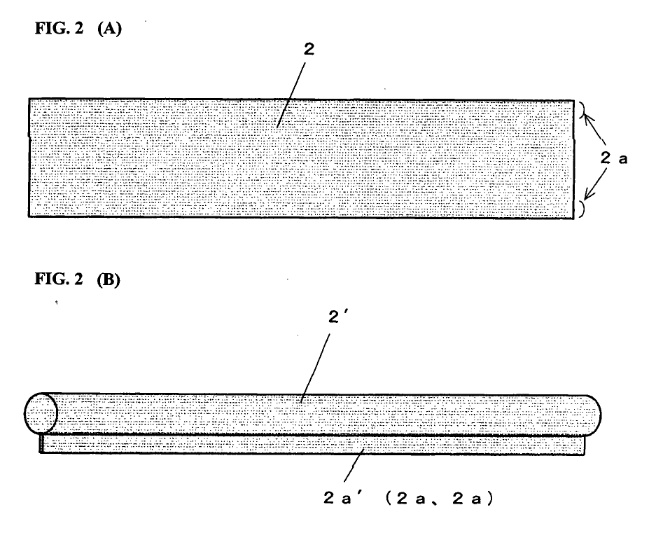

FIG. 2A is a view explaining a second embodiment of the present invention, wherein a woven fabric 2, for example, narrow woven fabric and the like composed of thermal fusion bonding textile yarns such as thermal fusion bonding polyester and the like is solidified while being applied with heat and molded to a pipe-like molded product 2′ as shown in FIG. 2B, and a fin portion 2a′ is formed by bonding and solidifying both the end edges of the woven fabric 2.

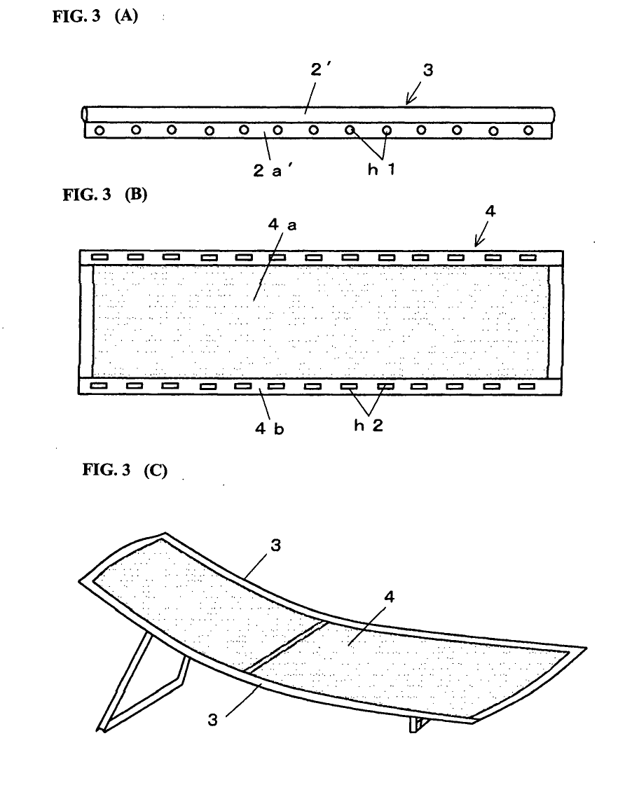

FIG. 3A shows a molded frame product 3 having many holes h1 formed to the fin portion 2a′ of the pipe-like molded product 2′ molded of the second embodiment. In contrast, in FIG. 3B, strip-like edge portions 4b, which are molded by the method of the first embodiment, are bonded to and integrated with the periphery of a mesh-like woven fabric 4a of crochet knit and the like, slender holes h2 are formed to the strip-like edge portions 4b, the slender holes h2 are overlapped on the holes h1 of the molded frame product 3, and a cord, a wire or the like (not shown) is caused to pass through the holes h1 and h2, thereby a bench product 4 is made as shown in FIG. 3C. Note that the pipe-like molded product 2′ can be also molded of cylindrical three-dimensional woven fabric to be described later.

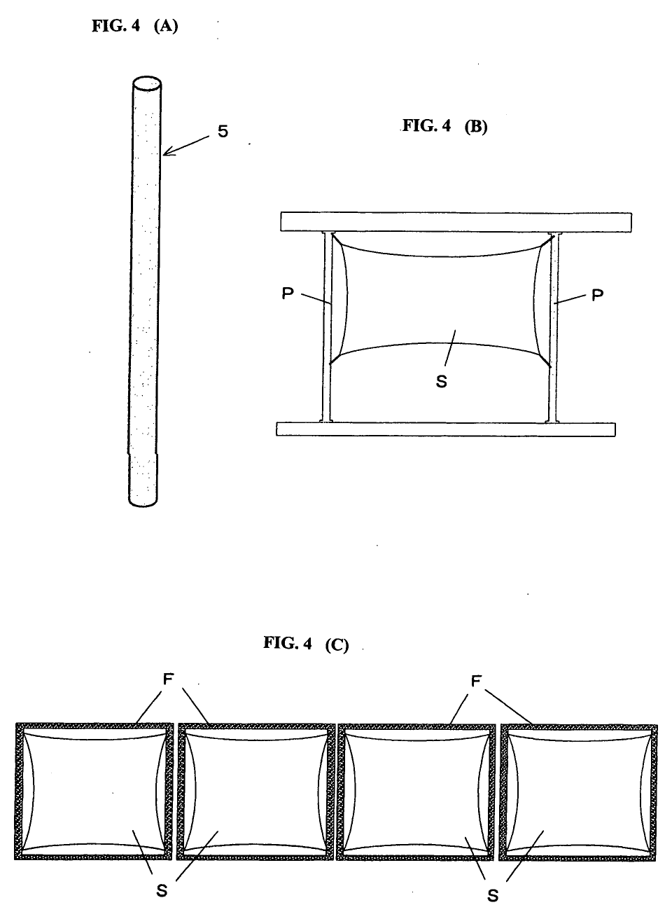

FIGS. 4A to 4C show a rod-like molded product 5 made by heat-molding a braid composed of thermal fusion bonding textile yarns such as thermal fusion bonding polyester and the like. The rod-like molded product 5 can be used, for example, as a pole P for stretching and attaching a sunshade S as shown in FIG. 4B or as a window frame F for stretching and attaching a sunshade S as shown in FIG. 4C. Note that the rod-like molded product 5 can be processed to an arbitrary curved shape.

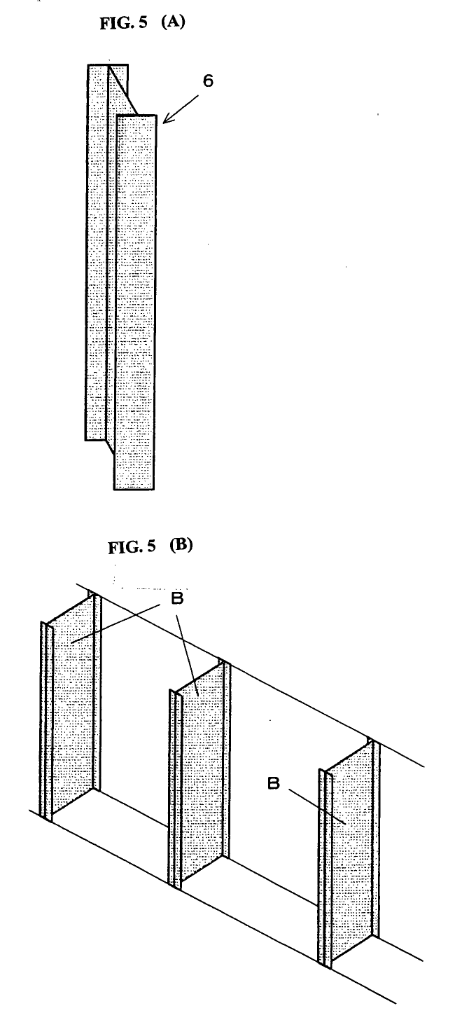

FIG. 5A shows a third embodiment of the present invention that is an H-shaped molded product 6 made by heat-molding three-dimensional woven fabric having an H-shaped cross section and composed of thermal fusion bonding textile yarns such as thermal fusion bonding polyester and the like. Partition boards B installed in veranda portions of a housing complex, for example, can be made using the H-shaped molded product 6 as shown in FIG. 5B.

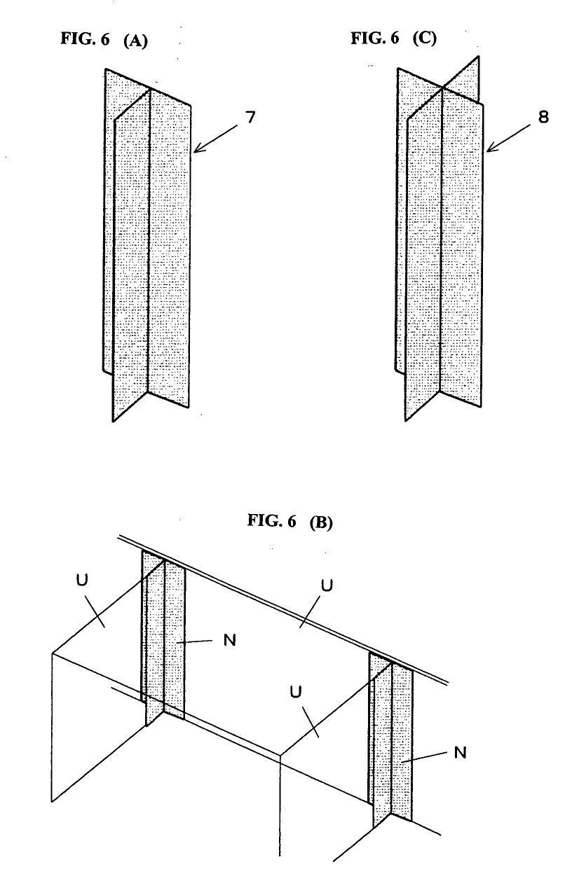

FIG. 6A shows a fourth embodiment of the present invention that is a product 7 made by heat-molding three-dimensional woven fabric having a T-shaped cross section and composed of thermal fusion bonding textile yarns such as thermal fusion bonding polyester and the like. Support members N of partitions U, for example, can be made using the product 7 as shown in FIG. 6B. Further, as shown in FIG. 6C, a cross-shaped molded product 8 can be also made by heat-molding three-dimensional woven fabric having a cross-shaped cross section and composed of thermal fusion bonding textile yarns such as thermal fusion bonding polyester and the like.

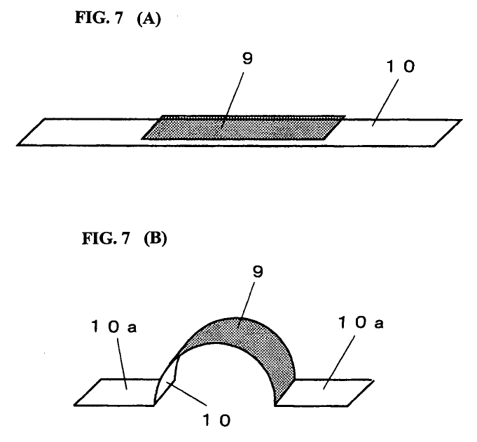

FIG. 7A shows a fifth embodiment of the present invention that is another embodiment made by overlapping a tape-like woven fabric 9, which is composed of thermal fusion bonding textile yarns such as thermal fusion bonding polyester and the like, on the intermediate portion of an ordinary woven fabric tape 10 and heat-molding them in a handle shape as shown in FIG. 7B. The molded product can be used as a handle of a bag by sewing the non-molded portions 10a of the woven fabric tape 10 on both the sides thereof to the bag. The molded products of the respective embodiments may be remolded to a different shape by being heated again.

Although the first to fifth embodiments are explained as to the woven fabric, the present invention is by no means limited thereto and may be a method of processing heat-processing a knitted fabric made by knitting thermal fusion bonding textile yarns such as thermal fusion bonding polyester and the like.

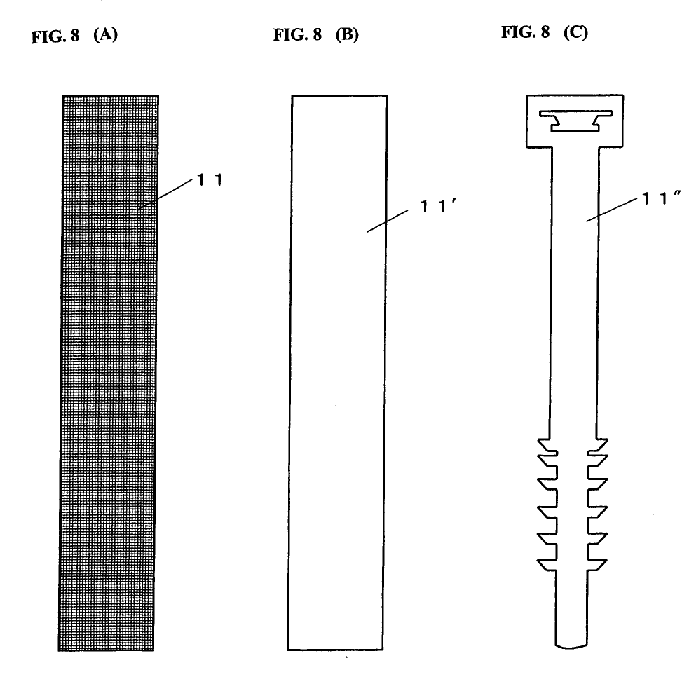

FIGS. 8A to 8C are views explaining a sixth embodiment of the present invention. In FIG. 8A, reference numeral 11 denotes narrow woven fabric whose warps and/or wefts are composed of thermal fusion bonding textile yarns such as thermal fusion bonding polyester and the like, and a solidified semi-finished product 11′ is obtained by applying heat to the narrow woven fabric 11 while pressing it as shown in FIG. 8B. Yarns used in the woven fabric 11 need not be entirely composed of thermal fusion bonding textile yarns and may be appropriately mixed with ordinary polyester textile or yarns according to a purpose of a molded product. Further, for example, the thickness of the warps may be partially changed or a new material (aramid yarns and the like) having strength may be used as the wefts. Further, textile and yarns to be used may be colored.

Subsequently, a binding tape 11″ as shown in FIG. 8C is obtained by cutting the solidified semi-finished product 11′. A cutting method includes physical cutting (cold cut) using scissors, a cutter (blade) and the like, punching (clicker), fusion-cutting (heat-cutting), sonic-cutting, laser-cutting (fusion-cutting by a laser beam), and high frequency cutting.

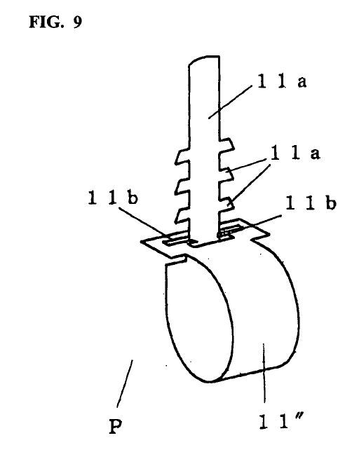

As shown in FIG. 9, the binding tape 11″ processed by the above method is wound around a to-be-bound article P, a clip portion 11a of the binding tape 11″ is tightened through a clip hole 11b, and a clip piece 11a′ of the clip portion 11a is clipped into a clip hole 11b′.

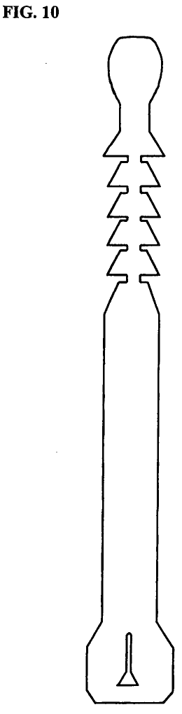

FIG. 10 is a view explaining a seventh embodiment of the present invention arranged as a binding tape. When the binding tape is used, an extreme end of the binding tape is inserted into a clip hole at the other end thereof after it is twisted 90°, and then the extreme end is twisted inversely in the narrow section of a clip portion at the other end so that it is clipped to a clipping piece.

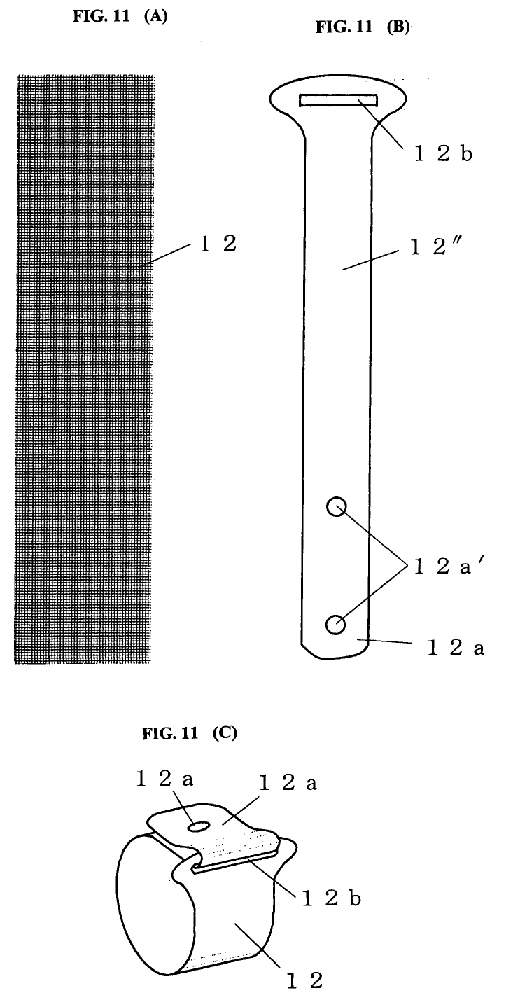

FIGS. 11A to 11C are views explaining an eighth embodiment of the present invention. In FIG. 11A, reference numeral 12 denotes narrow woven fabric whose warps and/or wefts are composed of thermal fusion bonding textile yarns such as thermal fusion bonding polyester and the like. As soon as the narrow woven fabric 12 is heat-melted, a binding tape 1211 as shown in FIG. 11B can be obtained. Since a feature of the embodiment resides in that heat-melting and cutting are executed in one process, fusion-cutting (heat-cut) and high frequency cutting are preferably employed as a cutting process. FIG. 11C is a perspective view showing a state of use of the binding tape 12″. An extreme end 12a is inserted into a slit hole 12b and folded back, two clip holes 12a and 12a′ are overlapped, and a clip such as a rivet and the like (not shown) is inserted into the holes and clipped thereto.

Although a heat-melting step and a cutting step are executed in one process in the eighth embodiment 8, the cutting step may be executed first and then the heat-melting step may be executed. Fusion-cutting (heat-cutting) and high frequency cutting are also preferably employed as the cutting process also in this case.

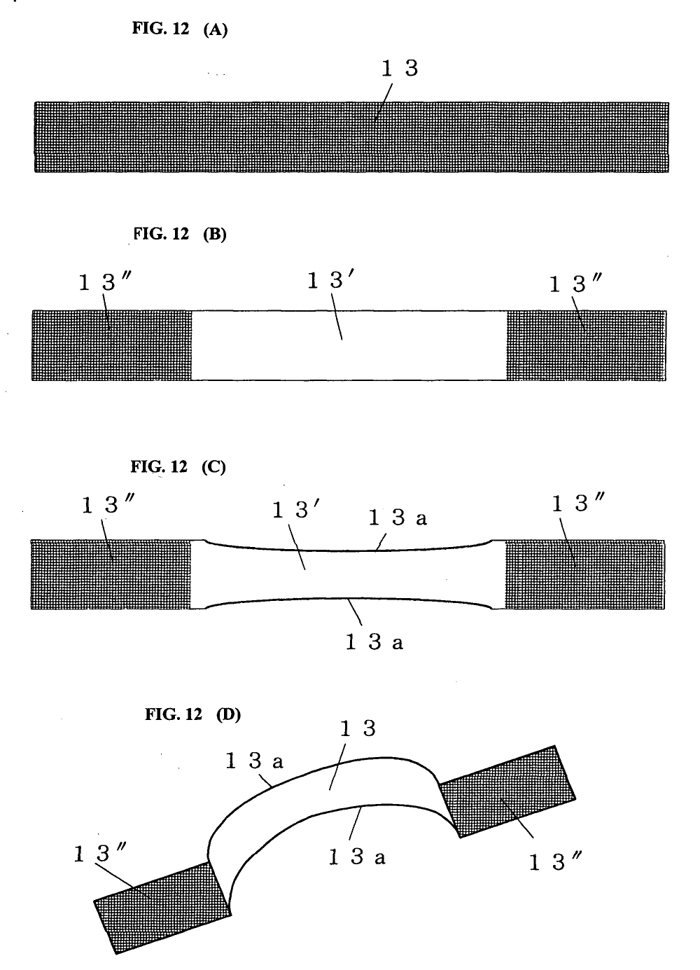

Although the narrow woven fabric is entirely heat-melted and cut in the embodiments described above, the present invention is by no means limited thereto, and, as shown in a ninth embodiment of FIGS. 12A to 12D, an intermediate portion 13′ of a narrow woven fabric may be heat-melted as well as subjected to a cutting process 13a to thereby make a handle as shown in FIG. 12D. In this case, the unprocessed portions (portions having flexibility as original woven fabric) of the narrow woven fabric on both the sides thereof may be sewed to a bag main body.

When an arc-shaped handle is made of the intermediate portion 13′, the intermediate portion 13′ may be molded at the same time when the woven fabric is heated and melted.

Although the narrow woven fabric is explained also in the embodiments 6 to 9, the woven fabric of the present invention is not limited to woven fabric having a narrow width.

1. A method of processing a woven or knitted fabric or braid comprising thermal fusion bonding yarns, the method comprising molding the fabric, or braid by heat-processing.

2. A method according to claim 1, further comprising remolding the molded fabric or braid by heat-processing again.

3. A method according to claim 1 or 2, wherein the fabric is a flat sheet.

4. A method according to claim 1 or 2, wherein the fabric is three-dimensional.

5. A method according to claim 1 or 2, wherein the fabric comprising thermal fusion bonding yarns is partly superposed on a second woven or knitted fabric, the second fabric not comprising thermal fusion bonding yarns, and the method further comprising heating and molding the fabric comprising thermal fusion bonding yarns integrally with it the second fabric.

6. A method of processing a woven or knitted fabric, comprising thermal fusion bonding textile, the method comprising:
melting and solidifying the fabric by heating the fabric; and
cutting the fabric to a predetermined shape.

7. A method of processing a woven or knitted fabric, comprising thermal fusion bonding textile, the method comprising:
heating and melting the woven fabric; and
cutting the fabric to a predetermined shape simultaneously with the heating and melting.

8. A method of processing a woven or knitted fabric comprising thermal fusion bonding textile, the method comprising:
fusion cutting the fabric as to a predetermined shape; and
melting and solidifying the fabric by heating the fabric.

9. A method according to claim 6, 7, or 8, wherein the cutting comprises partly cutting the fabric.

10. A method according to claim 6, 7, or 8, wherein the cutting comprises cutting the fabric while heat-molding the fabric.

11. A method according to claim 6, 7, or 8, further comprising changing thickness of the fabric or the thermal fusion bonding yarns of the fabric.

12. A method of processing fabric according to claim 6, 7, or 8, further comprising coloring the fabric.

13. A method according to claim 1, 6, 7 or 8 wherein the thermal fusion bonding yarns comprise polyester.
